(19) United States
(12) Patent Application Publication
(10) Pub. No.: US 2024/0119357 A1
(43) Pub. Date: Apr. 11, 2024

(54) ANALYSIS DEVICE, ANALYSIS METHOD, AND NON-TRANSITORY COMPUTER-READABLE MEDIUM HAVING PROGRAM STORED THEREON

(71) Applicant: NEC Corporation, Minato-ku, Tokyo (JP)

(72) Inventors: Keita SAKUMA, Tokyo (JP); Tomoya SAKAI, Tokyo (JP); Yoshio KAMEDA, Tokyo (JP); Hiroshi TAMANO, Tokyo (JP)

(73) Assignee: NEC Corporation, Minato-ku, Tokyo (JP)

(21) Appl. No.: 18/276,809

(22) PCT Filed: Feb. 25, 2021
(86) PCT No.: PCT/JP2021/007191

§ 371 Date: Aug. 10, 2023

(51) Int. Cl. G06N 20/00

(52) U.S. Cl. CPC G06N 20/00

(57) ABSTRACT

Provided are an analysis device, an analysis method, and a program capable of easily identifying a factor of a prediction error in prediction using a prediction model on the basis of various viewpoints. An analysis device (1) includes: a metric evaluation unit (2) that calculates and evaluates a plurality of types of metrics with respect to a prediction model, data of explanatory variables used in the prediction model, or data of target variables used in the prediction model; and a factor identification unit (3) that identifies a factor of an error in prediction by the prediction model according to a combination of evaluation results of the plurality of types of metrics.

### TECHNICAL FIELD

The present disclosure relates to an analysis device, an analysis method, and a non-transitory computer-readable medium having a program stored thereon.

### BACKGROUND ART

A predicted value of a prediction model for a certain data point may greatly deviate from an actual value due to factors such as overfitting or underfitting with respect to training data and a shift in data distribution. This is called a prediction error. In a case where analysis of a prediction error and an action for eliminating a factor of the prediction error are manually performed, a person in charge of analysis first performs specialized examination accompanied by multifaceted analysis based on a plurality of metrics using a prediction model, training data, and the like to identify the factor. Next, the person in charge of analysis devises an action for eliminating the found factor and executes the action.

As techniques related to evaluation of a prediction model, some techniques are known. For example, a metric monitoring system described in Non Patent Literature 1 continuously evaluates a plurality of metrics and presents an evaluation result to a user of the system. In addition, a prediction model maintenance system described in Patent Literature 1 continuously evaluates prediction accuracy and a magnitude of distribution shift of data, and when a deterioration state of a prediction model is detected from an evaluation result, automatically performs re-learning to update the model.

### CITATION LIST

### Non Patent Literature

Non Patent Literature 1: Polyzotis, N., Zinkevich, M., Roy, S., Breck, E., & Whang, S. “Data validation for machine learning.” Proceedings of Machine Learning and Systems 1 (2019): 334-347.

### PATENT LITERATURE

Patent Literature 1: Japanese Unexamined Patent Application Publication No. 2019-87101

### SUMMARY OF INVENTION

### Technical Problem

The metric monitoring system of Non Patent Literature 1 only calculates a plurality of metrics individually and individually presents a determination result of each metric for each metric. For this reason, identifying a factor of a prediction error still requires expert consideration by a person in charge of analysis. In addition, the prediction model maintenance system of Patent Literature 1 does not identify a factor of a prediction error based on evaluation results with respect to a plurality of metrics.

Therefore, in view of the above problems, a main object of the present disclosure is to provide an analysis device, an analysis method, and a program capable of easily identifying a factor of a prediction error in prediction using a prediction model on the basis of various viewpoints.

### Solution to Problem

An analysis device according to a first aspect of the present disclosure includes:
a metric evaluation means for calculating and evaluating a plurality of types of metrics with respect to a prediction model, data of explanatory variables used in the prediction model, or data of target variables used in the prediction model; and
a factor identification means for identifying a factor of an error in prediction by the prediction model according to a combination of evaluation results of the plurality of types of the metrics.

An analysis method according to a second aspect of the present disclosure includes:
calculating and evaluating a plurality of types of metrics with respect to a prediction model, data of explanatory variables used in the prediction model, or data of target variables used in the prediction model; and
identifying a factor of an error in prediction by the prediction model according to a combination of evaluation results of the plurality of types of the metrics.

A program according to a third aspect of the present disclosure causes a computer to execute:
a metric evaluation step of calculating and evaluating a plurality of types of metrics with respect to a prediction model, data of explanatory variables used in the prediction model, or data of target variables used in the prediction model; and
a factor identification step of identifying a factor of an error in prediction by the prediction model according to a combination of evaluation results of the plurality of types of the metrics.

### Advantageous Effects of Invention

According to the present disclosure, it is possible to provide an analysis device, an analysis method, and a program capable of easily specifying a factor of a prediction error in prediction using a prediction model on the basis of various viewpoints.

### BRIEF DESCRIPTION OF DRAWINGS

FIG. 1 is a block diagram illustrating an example of a configuration of an analysis device according to an outline of an example embodiment.

FIG. 2 is a block diagram illustrating an example of a configuration of an analysis device according to an example embodiment.

FIG. 3 is a schematic diagram illustrating an example of information stored in a storage unit.

FIG. 4 is an explanatory diagram illustrating an example of combinations of determination results for a metric.

FIG. 5 is an explanatory diagram illustrating an example of a factor determination rule in a table format.

FIG. 6 is an explanatory diagram illustrating an example of a factor determination rule in a flowchart format.

FIG. 7 is an explanatory diagram illustrating an example of an action determination rule.

FIG. 8 is a schematic diagram illustrating an example of image data generated by a visualization unit.

FIG. 9 is a schematic diagram illustrating an example of image data generated by the visualization unit.

FIG. 10 is a schematic diagram illustrating an example of image data generated by the visualization unit.

FIG. 11 is a schematic diagram illustrating an example of image data generated by the visualization unit.

FIG. 12A is a schematic diagram illustrating an example of a user interface.

FIG. 12B is a schematic diagram illustrating an example of the user interface.

FIG. 12C is a schematic diagram illustrating an example of the user interface.

FIG. 12D is a schematic diagram illustrating an example of the user interface.

FIG. 13 is a schematic diagram illustrating an example of a hardware configuration of the analysis device according to an example embodiment.

FIG. 14 is a flowchart illustrating an operation example of the analysis device of the example embodiment.

FIG. 15 is a schematic diagram illustrating examples of a factor determination rule and an action determination rule.

### EXAMPLE EMBODIMENT

### Outline of Example Embodiments

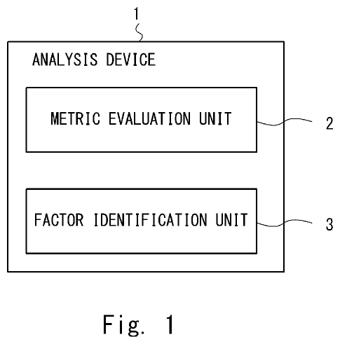

Before describing the details of an example embodiment, an outline of the example embodiment will be described first. FIG. 1 is a block diagram illustrating an example of a configuration of an analysis device 1 according to an outline of an example embodiment. As illustrated in FIG. 1, the analysis device 1 includes a metric evaluation unit 2 and a factor identification unit 3.

The metric evaluation unit 2 calculates a plurality of types of metrics (or indexes) with respect to a prediction model, data of explanatory variables used in the prediction model, or data of target variables used in the prediction model. Then, the metric evaluation unit 2 evaluates each of the plurality of types of calculated metrics. The metric evaluation unit 2 calculates a predetermined arbitrary metric. For example, the metric may be the accuracy of the prediction model, may be an abnormality score of a value of an explanatory variable or an target variable in data (hereinafter, referred to as a prediction error sample) that failed to predict in prediction using the prediction model, or may be a magnitude of temporal shift of a distribution of explanatory variables or target variables. Note that these are merely examples, and the metric evaluation unit 2 may calculate other metrics.

The factor identification unit 3 identifies a factor of an error in prediction by the prediction model according to combination of evaluation results from the metric evaluation unit 2 with respect to each of the plurality of types of metrics. The factor identification unit 3 identifies a factor by using, for example, a predetermined rule for associating a combination of evaluation results with a factor.

According to the analysis device 1, a plurality of types of metrics are evaluated, and a factor according to combinations of evaluation results for the metrics is automatically identified. Therefore, according to the analysis device 1, a factor of a prediction error in prediction using the prediction model can be easily identified on the basis of various viewpoints.

### Details of Example Embodiments

Hereinafter, example embodiments will be described in detail with reference to the drawings. When the prediction model causes a prediction error, that is, when the prediction model fails to predict a certain data point, the analysis device of the present example embodiment identifies a prediction error factor for the data point (prediction error sample) by analyzing the prediction error using a plurality of metrics. Note that the target prediction model is arbitrary, and may be, for example, a regression model or a classification model. In a case where the target model is a regression model, the analysis device of the present example embodiment identifies, for example, a factor that a predicted value of an target variable is not appropriate. In addition, in a case where the target prediction model is a classification model, the analysis device of the present example embodiment identifies a factor that a predicted value of a label, a classification score, or the like is not appropriate, for example.

The analysis device of the present example embodiment calculates a plurality of metrics using a prediction error sample, training data, and the like, and performs analysis using the plurality of metrics to identify a prediction error factor. Examples of metrics to be used include an evaluation metric of a prediction model such as a mean square error (accuracy of the prediction model), an abnormality score of a prediction error sample calculated using an abnormality detection method, a magnitude of distribution shift of data calculated from a distance between distributions of explanatory variables of training data and operation data, and the like.

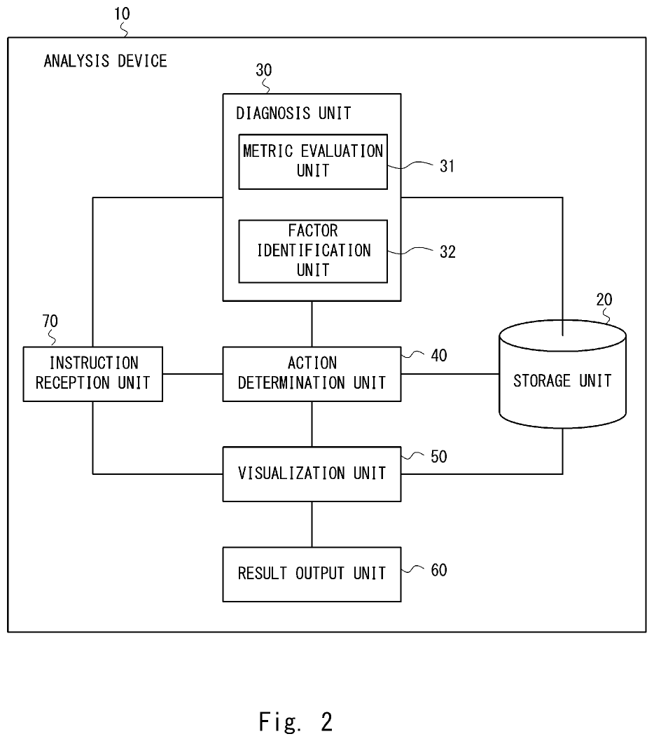

FIG. 2 is a block diagram illustrating an example of a configuration of the analysis device 10 according to the example embodiment. As illustrated in FIG. 2, the analysis device 10 includes a storage unit 20, a diagnosis unit 30, an action determination unit 40, a visualization unit 50, a result output unit 60, and an instruction reception unit 70.

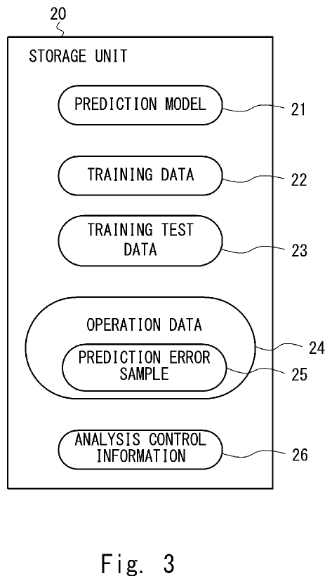

First, the storage unit 20 will be described. The storage unit 20 stores information necessary for analysis of a prediction error factor. Specifically, as illustrated in FIG. 3, the storage unit 20 stores a prediction model 21, training data 22, training test data 23, operation data 24, and analysis control information 26.

The prediction model 21 is a prediction model trained using the training data 22. That is, the prediction model 21 is a trained model. The prediction model 21 has a function as a function of outputting a predicted value of an target variable when input data (data of an explanatory variable) is input. As described above, the model type of the prediction model 21 is not particularly limited.

The training data 22 is data used for training, parameter tuning, and the like of the prediction model 21, and is a set of data of an explanatory variable and data of an target variable.

The training test data 23 is data used to evaluate generalization performance of the prediction model 21 at the time of training the prediction model 21, and is a set of data of explanatory variables and data of target variables. The training data 22 and the training test data 23 can be said to be data in a training phase with respect to the prediction model 21.

The operation data 24 is data obtained at the time of operation of the prediction model 21, and is data including data of explanatory variables used to obtain prediction by the prediction model 21 and actual values of target variables corresponding to the data of the explanatory variables. The operation data 24 may include predicted values of the target variables corresponding to the data of the explanatory variables, predicted by the prediction model 21, in addition to the actual values of the target variables corresponding to the data of the explanatory variables.

The operation data 24 includes a prediction error sample 25. The prediction error sample 25 is designated by, for example, a user of the analysis device 10 from the operation data 24 as a sample in which a prediction error has occurred. In the present example embodiment, the analysis device 10 uses the operation data 24 designated by an instruction received by the instruction reception unit 70 which will be described later as the prediction error sample 25. The number of designated prediction error samples 25 is not limited to one, and may be plural. When a plurality of prediction error samples 25 are designated, the analysis device 10 sequentially identifies a prediction error factor for each of the prediction error samples.

The analysis control information 26 is information for controlling processing of the analysis device 10. Examples of the analysis control information 26 include a program in which an algorithm used by the diagnosis unit 30 to evaluate a metric is implemented, a setting value of a threshold used by the diagnosis unit 30 to evaluate a metric, information defining a rule used by the diagnosis unit 30 or the action determination unit 40, and the like. Note that the storage unit 20 may store a plurality of pieces of analysis control information 26 that can be substituted for each other. For example, the storage unit 20 may store, as the analysis control information 26, various algorithms for calculating the same type of metric, or may store various setting values (various evaluation algorithms) of thresholds used for evaluation of metrics. Furthermore, for example, the storage unit 20 may store various types of definition information of rules used by the diagnosis unit 30 or the action determination unit 40 as the analysis control information 26. When a plurality of pieces of analysis control information 26 that can be substituted for each other are stored, the analysis device 10 performs processing using the analysis control information 26 designated by an instruction received by the instruction reception unit 70. With such a configuration, the analysis device 10 can perform analysis by various analysis methods.

Next, the diagnosis unit 30 will be described. The diagnosis unit 30 identifies a prediction error factor for the prediction error sample 25 using information stored in the storage unit 20. Specifically, the diagnosis unit 30 calculates a metric and evaluates a calculation result of the metric for each of a plurality of metrics. Then, the diagnosis unit 30 identifies a prediction error factor using each evaluation result obtained for each metric.

As illustrated in FIG. 2, the diagnosis unit 30 includes a metric evaluation unit 31 and a factor identification unit 32. The metric evaluation unit 31 corresponds to the metric evaluation unit 2 in FIG. 1. Further, the factor identification unit 32 corresponds to the factor identification unit 3 in FIG. 1. Therefore, the metric evaluation unit 31 calculates a plurality of types of metrics and evaluates each metric. In addition, the factor identification unit 32 identifies a factor of an error in prediction by the prediction model 21 according to combinations of evaluation results of the plurality of types of metrics from the metric evaluation unit 31. Details of the metric evaluation unit 31 and the factor identification unit 32 will be described below.

The metric evaluation unit 31 calculates a plurality of metrics necessary for analysis of a prediction error factor and determines calculation results of the metrics using information in the storage unit 20. For example, the metric evaluation unit 31 calculates an abnormality score of an explanatory variable of the prediction error sample 25 with respect to the training data 22 and evaluates the calculated abnormality score. In this case, the metric evaluation unit 31 evaluates the metric by determining whether the calculated value of the abnormality score is a value at which the prediction error sample 25 is recognized as an abnormal sample. That is, in this case, the metric evaluation unit 31 determines whether the prediction error sample 25 is an abnormal sample using the calculated abnormality score. As another example, the metric evaluation unit 31 calculates an inter-distribution distance (hereinafter, it is also referred to as a magnitude of distribution shift of data) between the training data 22 and the operation data 24, and evaluates the calculated inter-distribution distance. In this case, the metric evaluation unit 31 evaluates the metric by determining whether the calculated value of the inter-distributions distance is a value at which it is recognized that there is a shift in the distribution of data between training and operation. That is, in this case, the metric evaluation unit 31 determines whether or not a shift in the distribution of data occurs between training and operation by using the calculated inter-distribution distance. Note that these are merely examples, and the metric evaluation unit 31 can perform calculation and evaluation with respect to various types of metrics. As described above, in the present example embodiment, the metric evaluation unit 31 performs predetermined determination on metrics as evaluation on the metrics. Determination on each metric is performed using, for example, a threshold stored as the analysis control information 26. Note that a parameter for specifying the threshold may be stored as the analysis control information 26 instead of the threshold itself.

Here, the type and number of metrics calculated to identify a factor of a prediction error for one prediction error sample 25 are arbitrary, but it is preferable to use two or more metrics. This is because, by using a large number of metrics, more multifaceted analysis can be achieved and the number of types of prediction error factors that can be identified can be increased.

In addition, an evaluation method for each metric in the metric evaluation unit 31 is arbitrary. For example, when an abnormality score of an explanatory variable of the prediction error sample 25 is calculated and it is determined whether the prediction error sample is an abnormal sample, various abnormality detection methods such as a hoteling method and a k-nearest neighbor method can be used. As described above, a program for realizing an evaluation method (algorithm) used by the metric evaluation unit 31 for each metric is stored in the storage unit 20 as the analysis control information 26, for example. Furthermore, as described above, the analysis control information 26 may include a plurality of programs in which different algorithms are implemented for the same type of metric. For example, the analysis control information 26 may include two programs, i.e., a program implementing a hoteling method and a program implementing a k-nearest neighbor method, as programs implementing an evaluation method (algorithm) regarding an abnormality score of an explanatory variable of the prediction error sample 25. According to such a configuration, the diagnosis unit 30 can evaluate metrics using various evaluation methods by switching the analysis control information 26 to be used.

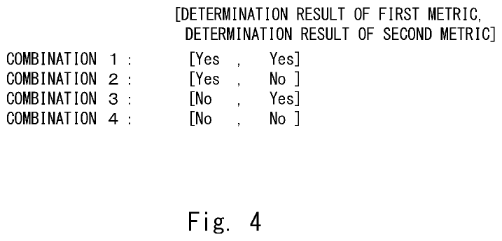

The factor identification unit 32 identifies a prediction error factor according to combinations of evaluation results of the plurality of types of metrics from the metric evaluation unit 31. In the present example embodiment, the factor identification unit 32 identifies a prediction error factor according to combinations of determination results of predetermined determinations for each metric. Specifically, the factor identification unit 32 identifies a prediction error factor by using a predetermined rule (hereinafter, a factor determination rule) for associating the prediction error factor with a combination of a plurality of determination results. FIG. 4 illustrates combinations of determination results in a case where two different determinations (Yes, No) have been performed. That is, FIG. 4 illustrates combinations of determination results for a first metric and determination results for a second metric obtained by the metric evaluation unit 31. In the present example embodiment, as illustrated in FIG. 4, when a determination result for any metric is different, the factor determination rule is applied as a different combination. In this way, by integrally considering a plurality of determination results as a combination of the determination results instead of individually considering the plurality of determination results, it is possible to identify a prediction error factor according to multifaceted analysis using a plurality of metrics. As a result, a process in which the user analyzes a determination result for each metric to identify a prediction error factor becomes unnecessary.

As described above, the factor identification unit 32 identifies a factor of the error in prediction by the prediction model 21 according to the rule for associating a factor with a combination of evaluation results (determination results) of a plurality of types of metrics. The content of the factor determination rule used by the factor identification unit 32 is arbitrary. In addition, as described above, the factor determination rule is stored in the storage unit 20, for example, as the analysis control information 26. Furthermore, as described above, the analysis control information 26 may include a plurality of factor determination rules having different types or numbers of determination results to be analyzed. According to such a configuration, the diagnosis unit 30 can analyze a prediction error using different factor determination rules by switching the analysis control information 26 to be used. Note that since it is necessary to obtain a determination result corresponding to a factor determination rule to be used, the type and number of metrics to be evaluated by the metric evaluation unit 31 depend on the factor determination rule.

In addition, the form of the factor determination rule is also arbitrary. The factor determination rule used by the factor identification unit 32 may be, for example, a factor determination rule for allocating a combination of determination results to a prediction error factor using a table, or a factor determination rule for allocating a combination of determination results to a prediction error factor using a flowchart. These forms of the factor determination rule will be described below.

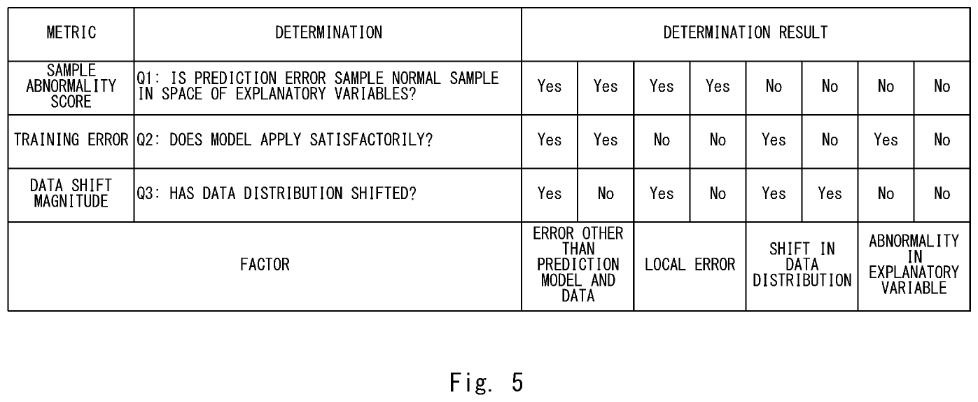

FIG. 5 illustrates an example of a factor determination rule in a table format used by the factor identification unit 32. In this example, the metric evaluation unit 31 generate a determination result of Yes or No for three questions Q1, Q2, and Q3 corresponding to three different metrics using information stored in the storage unit 20. In question Q1, whether the prediction error sample 25 is a normal sample is determined from an abnormality score of an explanatory variable of the prediction error sample 25 with respect to the training data 22. In question Q2, an evaluation metric such as a mean square error is calculated using a neighboring training sample and the prediction model 21 to determine whether the prediction model 21 applies satisfactorily to the training data 22 in the neighboring region. Here, the neighboring training sample refers to a sample in the training data 22 located in the neighboring region. In addition, the neighboring region refers to a range of values of explanatory variables determined to be close to values of explanatory variables of the prediction error sample 25. At this time, a specific definition method for the neighboring region is arbitrary, and for example, a region in which a distance (Euclidean distance or the like) from the prediction error sample 25 calculated using values of explanatory variables is equal to or less than a predetermined distance may be set as the neighboring region. In question Q3, whether there is a shift in a distribution of data between training and operation is determined using a magnitude of distribution shift of data between the distribution of explanatory variables of the training data 22 and the distribution of explanatory variables of the operation data 24.

The factor identification unit 32 identifies a prediction error factor using determination results obtained by the metric evaluation unit 31 and the factor determination rule of FIG. 5. There are eight types of combinations of the three types of determination results, and in the factor determination rule in a table format, a prediction error factor is assigned to each of the eight types. In the case of FIG. 5, eight types of combinations are assigned to four types of prediction error factors.

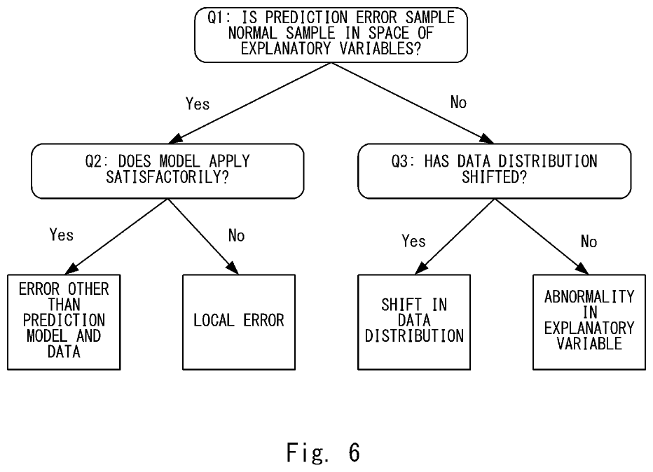

As described above, a factor determination rule in a flowchart format may be used as the factor determination rule used by the factor identification unit 32. FIG. 6 illustrates an example of a factor determination rule in a flowchart format used by the factor identification unit 32. Note that the factor determination rule illustrated in FIG. 5 and the factor determination rule illustrated in FIG. 6 have different formats, but the rules for assigning factors to determination results are the same. In the factor determination rule in a flowchart format, each determination can be arranged on the flowchart in consideration of a dependence relationship of the determination of each metric. This will be described focusing on the relationship among Q1, Q2, and Q3 in FIG. 6.

The factor determination rule in the flowchart format shown in FIG. 6 has a structure in which Q1 is determined first, Q2 is determined when the determination result of Q1 is Yes, and Q3 is determined when the determination result of Q1 is No. Q1, Q2, and Q3 in the factor determination rule of FIG. 6 are similar to Q1, Q2, and Q3 in the factor determination rule of FIG. 5. As described above, a factor determination rule in a flowchart format may be used as the factor determination rule used by the factor identification unit 32. That is, the factor identification unit 32 may identify a factor of an error in prediction by the prediction model 21 according to a combination of an evaluation result (determination result) of a predetermined metric among a plurality of types of metrics and an evaluation result of a metric selected depending on the evaluation result of the predetermined metric. That is, the factor identification unit 32 may use a flowchart for sequentially identifying metrics to be used to identify factors on the basis of evaluation results (determination results) of the metrics.

When the determination result of Q1 is Yes, it means that the explanatory variables of the prediction error sample 25 are normal and a sample whose explanatory variables are similar to those of the prediction error sample 25 can occur with a high frequency. Therefore, it is assumed that there are a large number of neighboring training samples in the training data 22. In this case, if actual values of target variables of these neighboring training samples are appropriately trained, the prediction model 21 becomes a prediction model with high prediction accuracy. In addition, when the determination result of Q1 is Yes, since the prediction error sample 25 is a normal sample, there is a low possibility of the data distribution changing between training and operation. Therefore, when the determination result of Q1 is Yes, determination of Q3 is meaningless.

If the determination result of Q1 is Yes, subsequently, it is determined whether the prediction model 21 has appropriately learned actual values of the target variables of the neighboring training samples in Q2. When the determination result of Q2 is Yes, since the prediction model 21 is assumed to be a prediction model with high prediction accuracy, it is expected that no prediction error occurs. Therefore, factors other than the prediction model and data, such as analysis of a sample without a prediction error due to a malfunction of the analysis device 10 (a malfunction of a user interface or the like) or an erroneous operation of a user of the system as the prediction error sample 25, are conceived. Therefore, in this case, the factor identification unit 32 determines that a factor of a prediction error is an error other than the prediction model and data with reference to the factor determination rule. In addition, when the determination result of Q2 is No, it is conceivable that the prediction model 21 cannot appropriately learn the actual values of the target variables of the neighboring training samples due to underfitting or the like. Therefore, in this case, it is concluded that the prediction model 21 is a model having a local error around the prediction error sample 25. Therefore, in this case, the factor identification unit 32 determines that a factor of a prediction error is a local error with reference to the factor determination rule. As described above, since the determination of Q2 is meaningful only when the determination result of Q1 is Yes, Q2 is arranged after Q1.

On the other hand, when the determination result of Q1 is No, it means that there are not sufficient neighboring training samples in the training data 22, and in this case, it is impossible to accurately determine whether the prediction model 21 applies satisfactorily to the neighboring training samples in Q2. Therefore, when the determination result of Q1 is No, it is important to identify the reason why a sample having a high abnormality score such as the prediction error sample 25 has occurred. Therefore, in Q3, it is determined whether the distribution of the data has shifted with the lapse of time. Hereinafter, a shift with the lapse of time is referred to as a temporal shift. When the determination result of Q3 is Yes, conclusion is made as follows. That is, since the frequency at which a sample having a high abnormality score is generated increases as compared with the training data 22 due to a temporal shift in the distribution of the data, as a result, it is concluded that the prediction error sample 25 having a high abnormality score as compared with the training data 22 is generated and a prediction error occurs. Therefore, in this case, the factor identification unit 32 determines that the factor of the prediction error is a shift in the data distribution with reference to the factor determination rule. In addition, when the determination result of Q3 is No, since the distribution of the data does not shift with time, it is concluded that the prediction error sample 25 is an abnormal sample caused by a factor other than a temporal shift in the data distribution. Therefore, in this case, the factor identification unit 32 determines that the factor of the prediction error is an abnormality in the explanatory variables due to some reason with reference to the factor determination rule. As described above, the factor determination rule in a flowchart format has a structure in which the details of the reason why the determination result of Q1 is No are determined in Q3, and thus Q3 is arranged after Q1.

As described above, in the factor determination rule illustrated in FIG. 5 and the factor determination rule illustrated in FIG. 6, the content of question Q and the finally identified prediction error factor are common, and the rules are the same. However, when a factor determination rule in which the dependence relationship of determination results of each metric is explicitly considered, such as a factor determination rule in a flowchart format, is used, the user can easily interpret an identified prediction error factor, and computer resources are saved. This will be described using the factor determination rule illustrated in FIG. 6 as an example.

When the factor determination rule in a flowchart format as illustrated in FIG. 6 is used, there is a branch in the flowchart, and thus it is not necessary to determine all questions Q, and thus questions Q to be determined are narrowed down. Therefore, the number of combinations that need to be considered by the analysis device 10 at the time of analysis decreases as compared to a case where combinations of determination results for all metrics are considered as in the factor determination rule in a table format illustrated in FIG. 5. That is, calculation and evaluation of some metrics can be omitted. This leads to saving of computer resources. In addition, it is possible to explain why a prediction error factor determined using a factor determination rule in a flowchart format is determined as such a prediction error factor when determination results are sequentially followed along the flowchart. Therefore, when a factor determination rule in a flowchart format is used, the user can easily understand the meaning of an identified prediction error factor.

Next, the action determination unit 40 will be described. The action determination unit 40 determines an action (work) for eliminating the factor identified by the factor identification unit 32 of the diagnosis unit 30. In the present example embodiment, the action determination unit 40 creates an action proposal sentence (hereinafter, an action proposal) for eliminating a prediction error factor for the prediction error factor identified by the diagnosis unit 30. At this time, the action determination unit 40 creates an action proposal by using a predetermined rule (hereinafter, an action determination rule) for allocating the action proposal to the prediction error factor.

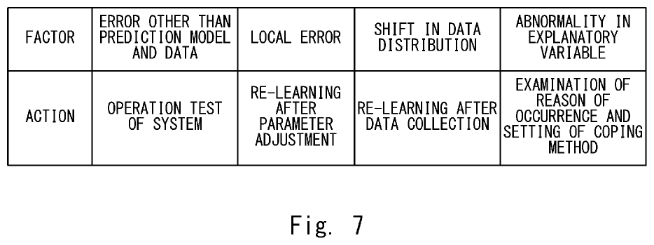

Here, an example of the action determination rule is illustrated in FIG. 7. The action determination rule illustrated in FIG. 7 is a rule for assigning an action proposal to an identified factor in a one-to-one correspondence. In a case where an identified prediction error factor is an “error other than the prediction model and data”, it is necessary to examine whether or not a problem such as a malfunction of the system or an erroneous operation of the user occurs by performing an operation test or the like of the system (analysis device 10). Therefore, in this case, the action determination unit 40 creates an action proposal recommending execution of such an action with reference to the action determination rule. Furthermore, in a case where the identified prediction error factor is a “local error”, there is a high possibility of underfitting and the like, and thus it is necessary to adjust hyperparameters at the time of learning the prediction model and then perform re-learning. Therefore, in this case, the action determination unit 40 creates an action proposal recommending execution of such an action with reference to the action determination rule. In addition, in a case where the identified prediction error factor is “shift in a data distribution”, it means that a large number of pieces of operation data are present in the region of explanatory variables that the prediction model 21 has not learned. Therefore, it is possible to improve the accuracy of the prediction model by adding the operation data to the training data and performing re-learning. Therefore, in this case, the action determination unit 40 creates an action proposal recommending execution of such an action with reference to the action determination rule. In addition, in a case where the prediction error factor is “abnormality of an explanatory variable”, it means that the prediction error sample 25 has an abnormal explanatory variable value regardless of a shift in the distribution. For this reason, it is necessary to investigate the reason why such a sample has occurred and determine a coping method when a similar sample occurs in the future. Therefore, in this case, the action determination unit 40 creates an action proposal recommending execution of such an action with reference to the action determination rule.

In this manner, the action determination unit 40 determines an action to be performed to eliminate the prediction error factor identified by the factor identification unit 32. As a result, it is possible to output an action proposal for eliminating the prediction error factor, and thus the user can immediately start an action necessary for improvement. That is, the user does not need to perform examination for determining an action from the identified factor.

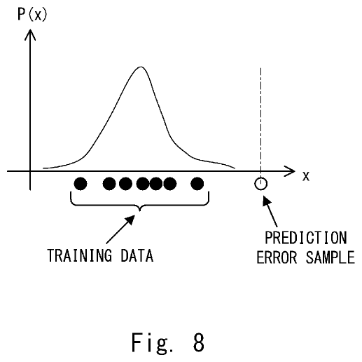

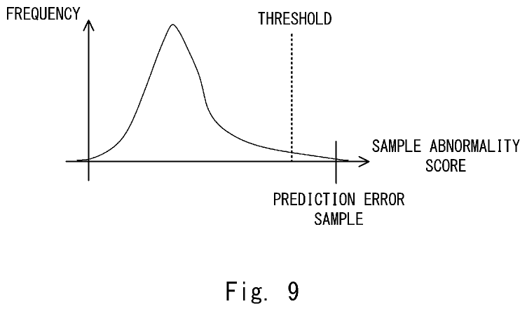

Next, the visualization unit 50 will be described. The visualization unit 50 visualizes information describing each determination result in the diagnosis unit 30. A method of visualizing the information describing each determination result is arbitrary. For example, in the case of visualization regarding an abnormality score of a prediction error sample, the visualization unit 50 may generate image data of a graph as illustrated in FIG. 8. FIG. 8 shows a graph in which a probability density function regarding an explanatory variable estimated from data of explanatory variables of the training data 22 and actual values of the explanatory variables of the prediction error sample 25 are plotted. Furthermore, in the case of visualization regarding an abnormality score of a prediction error sample, the visualization unit 50 may generate image data of a graph as illustrated in FIG. 9. FIG. 9 shows a graph in which a histogram of an abnormality score of each sample in the training data 22 with respect to the training data 22 and an abnormality score of an explanatory variable of the prediction error sample 25 with respect to the training data 22 are illustrated. By performing such visualization, it is possible to visually describe how abnormal the prediction error sample 25 is.

A program for generating information (image data) describing a determination result may be stored in the storage unit 20 as the analysis control information 26. In this case, the analysis control information 26 may hold a plurality of programs for realizing different visualization methods for a certain metric in order to perform different visualizations illustrated in FIGS. 8 and 9. According to such a configuration, the visualization unit 50 can realize different visualizations by switching the analysis control information 26 to be used at the time of performing visualization for explaining each determination result.

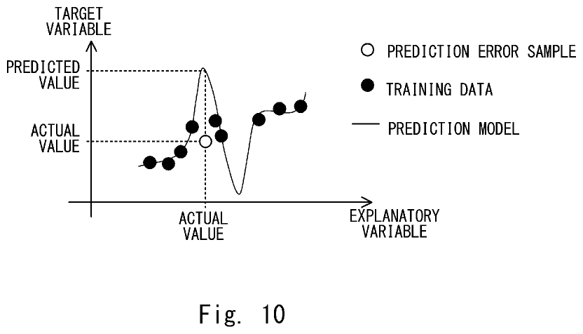

Note that, in the above description, visualization of an abnormality score of a prediction error sample has been described as an example, but the visualization unit 50 may visualize information describing other determination results. For example, the visualization unit 50 may generate image data of a graph as illustrated in FIG. 10 for visualization regarding whether a model applies satisfactorily to data. FIG. 10 illustrates a graph showing a predicted value of an target variable obtained by the prediction model 21 and an actual value of an target variable of the training data 22 in a neighboring region of the prediction error sample 25. By performing such visualization, it is possible to visually describe how the prediction model 21 is applied to the training data 22.

In this manner, the visualization unit 50 may generate image data of a predetermined graph corresponding to a metric. With such visualization, the user can visually confirm the validity of a determination result for each metric.

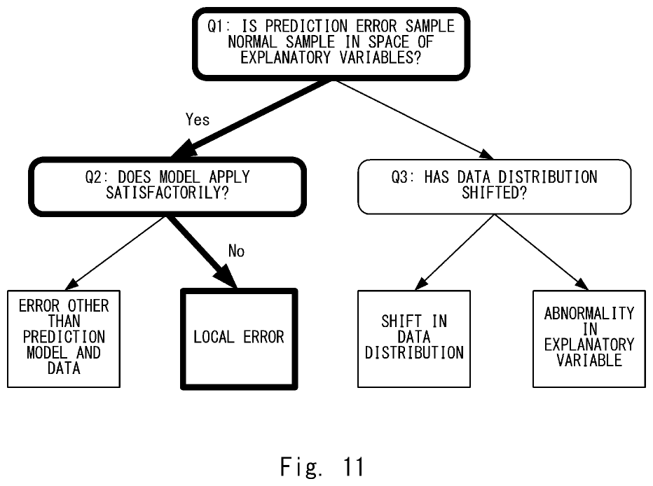

Furthermore, in the case of a factor determination rule in a flowchart format, the visualization unit 50 may generate image data describing a flow of a determination result in the flowchart as in FIG. 11. That is, the visualization unit 50 may generate image data representing a flowchart defining metrics used to identify a factor and an order of using the metrics and a transition history in the flowchart. By performing such visualization, the user can easily understand the meaning of an identified prediction error factor.

Next, the result output unit 60 will be described. The result output unit 60 outputs calculation results of metrics from the metric evaluation unit 31, determination results of the metrics from the metric evaluation unit 31, the prediction error factor identified by the factor identification unit 32, the action proposal created by the action determination unit 40, the image data created by the visualization unit 50, and the like. Note that the result output unit 60 may output all or only some of such information. The output method of the result output unit 60 is arbitrary, and the result output unit 60 may display the above-described information on, for example, a monitor (display) or the like. Furthermore, the result output unit 60 may transmit the above-described information to another device.

Next, the instruction reception unit 70 will be described. The instruction reception unit 70 receives an instruction from a user of the analysis device 10. For example, the instruction reception unit 70 receives an instruction to designate which sample of the operation data 24 is the prediction error sample 25. As a result, the user can easily change samples to be analyzed. A user interface of the instruction reception unit 70 may be displayed, for example, on a monitor (display). That is, the instruction reception unit 70 may display a screen for receiving an instruction on the monitor. The instruction reception unit 70 receives an instruction from the user via, for example, an input device (for example, a mouse, a keyboard, or the like) connected to the analysis device 10.

Note that, as described above, the instruction reception unit 70 may receive an instruction to designate a metric calculation algorithm or an evaluation algorithm. In this case, the metric evaluation unit 31 calculates or evaluates metrics by the calculation algorithm or the evaluation algorithm designated by the instruction. Further, the instruction reception unit 70 may receive an instruction to designate a factor determination rule. In this case, the factor identification unit 32 identifies a factor of an error in prediction by the prediction model 21 according to the factor determination rule designated by the instruction. With such a configuration, the user can easily change the analysis method. Note that the instruction is not limited to the above-described designation, and the instruction reception unit 70 may receive an instruction to designate an action determination rule or an instruction to designate a visualization method.

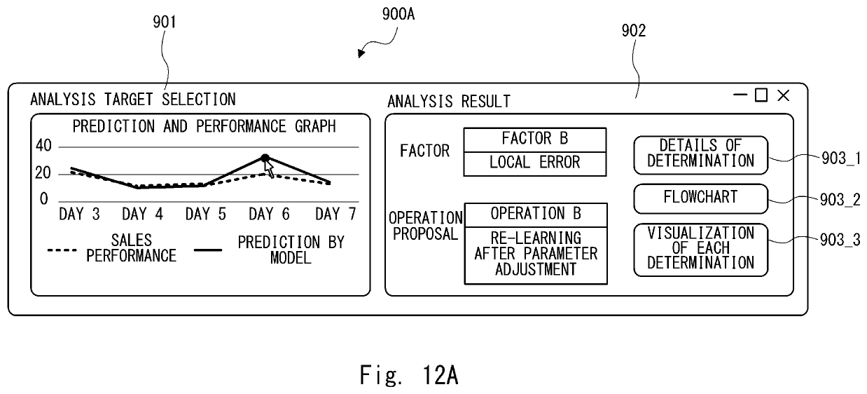

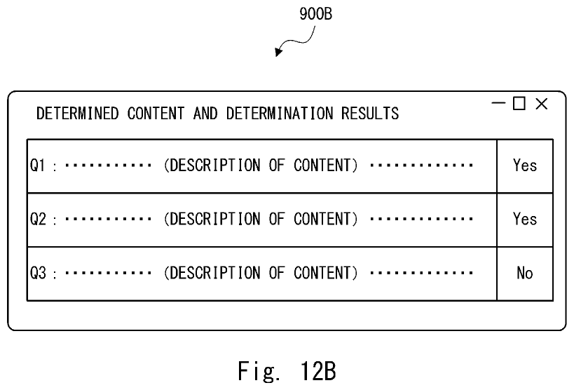

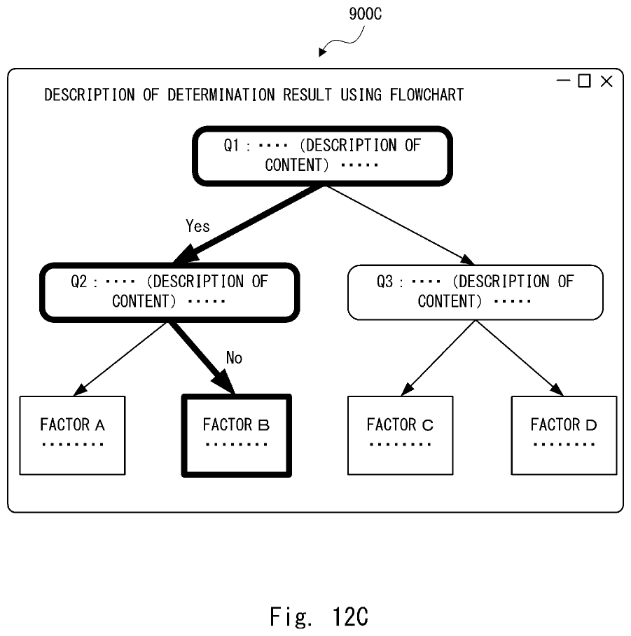

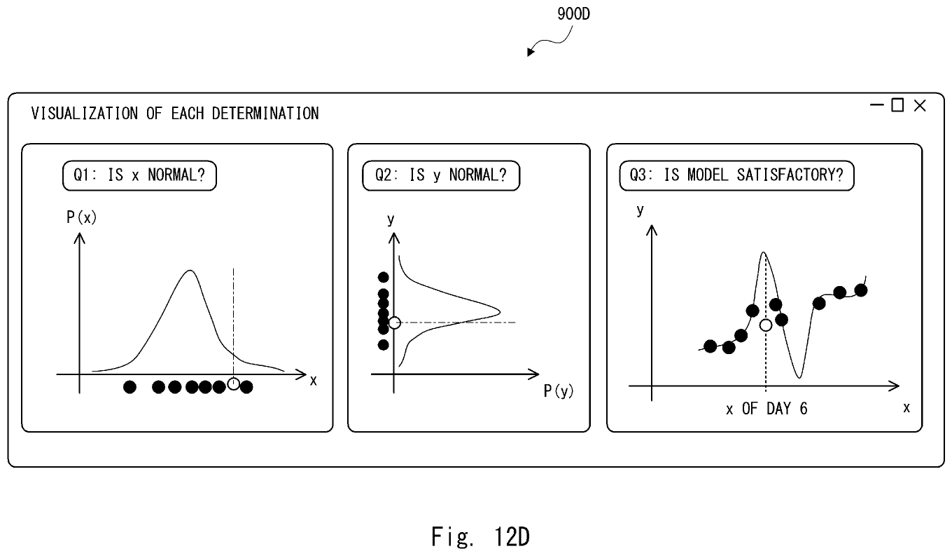

FIGS. 12A to 12D are schematic diagrams illustrating an example of a user interface provided by the result output unit 60 and the instruction reception unit 70 in the analysis device 10 of the present example embodiment. FIG. 12A illustrates an example of a window 900A including an analysis target selection screen 901 for designating a sample to be analyzed, that is, a prediction error sample 25, and an analysis result screen 902 for displaying an analysis result regarding a prediction error factor for the prediction error sample 25. The exemplified user interface is a user interface in which a prediction error factor and an action proposal are output to the analysis result screen 902 when a prediction error sample to be analyzed is selected through the analysis target selection screen 901. Furthermore, the window 900A includes a button 903_1 for displaying a window 900B, a button 903_2 for displaying a window 900C, and a button 903_3 for displaying a window 900D. Here, the window 900B (refer to FIG. 12B) is a window that displays details of determination by the metric evaluation unit 31. Furthermore, the window 900C (refer to FIG. 12C) is a window that displays an image for description using the flowchart as illustrated in FIG. 11. Furthermore, the window 900D (refer to FIG. 12D) is a window that displays an image for description using the graphs as illustrated in FIGS. 8 to 10. In this manner, the user can check various contents as necessary.

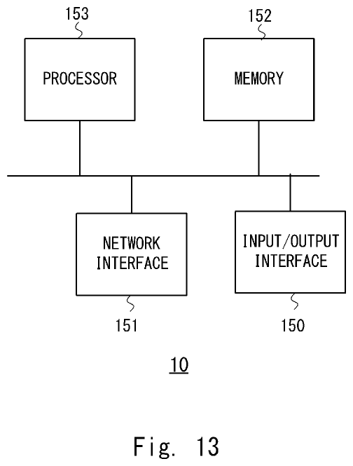

Next, a hardware configuration of the analysis device 10 will be described. FIG. 13 is a schematic diagram illustrating an example of the hardware configuration of the analysis device 10. As illustrated in FIG. 13, the analysis device 10 includes an input/output interface 150, a network interface 151, a memory 152, and a processor 153.

The input/output interface 150 is an interface for connecting the analysis device 10 and an input/output device. For example, an input device such as a mouse and a keyboard, and an output device such as a monitor (display) are connected to the input/output interface 150.

The network interface 151 is used to communicate with any other device as necessary. The network interface 151 may include, for example, a network interface card (NIC).

The memory 152 includes, for example, a combination of a volatile memory and a nonvolatile memory. The memory 152 is used to store software (a computer program) including one or more instructions executed by the processor 153, data used for various types of processing of the analysis device 10, and the like. For example, the above-described storage unit 20 may be realized by a storage device such as the memory 152.

The processor 153 reads and executes the software (computer program) from the memory 152 to perform processing of the diagnosis unit 30, the action determination unit 40, the visualization unit 50, the result output unit 60, and the instruction reception unit 70. The processor 153 may be, for example, a microprocessor, a micro processor unit (MPU), or a central processing unit (CPU). The processor 153 may include a plurality of processors.

As described above, the analysis device 10 has a function as a computer.

Furthermore, the program described above can be stored using various types of non-transitory computer-readable media and supplied to a computer. The non-transitory computer-readable media include various types of tangible storage media. Examples of non-transitory computer-readable media include a magnetic recording medium (for example, a flexible disk, a magnetic tape, or a hard disk drive), a magneto-optical recording medium (for example, a magneto-optical disk), a CD-read only memory (ROM) CD-R, a CD-R/W, and a semiconductor memory (for example, a mask ROM, a programmable ROM (PROM), an erasable PROM (EPROM), a flash ROM, and a random access memory (RAM)). In addition, the program may be supplied to a computer through various types of transitory computer readable media. Examples of transitory computer-readable media include electrical signals, optical signals, and electromagnetic waves. Transitory computer-readable media can supply the program to a computer via a wired communication path such as an electric wire and an optical fiber, or a wireless communication path.

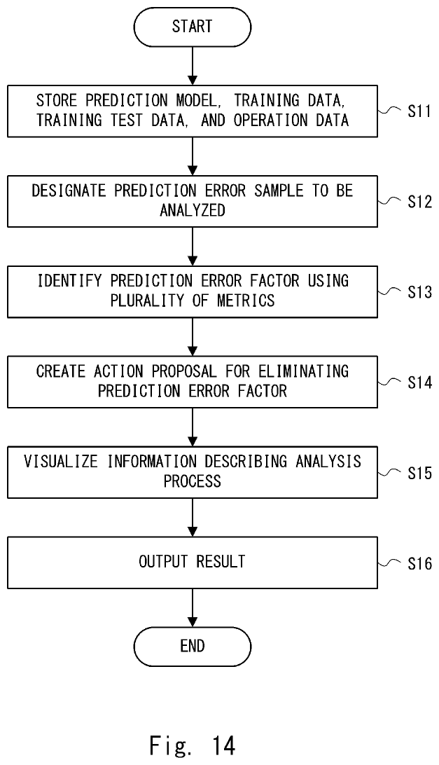

Next, the operation of the analysis device 10 of the present example embodiment will be described. FIG. 14 is a flowchart illustrating an operation example of the analysis device 10 of the present example embodiment.

First, as preparation before analysis processing performed by the analysis device 10, the prediction model 21, the training data 22, the training test data 23, and the operation data 24 are stored in the storage unit 20 (step S11). For example, these pieces of information are stored in the storage unit 20 by user operation. The analysis control information 26 is stored in the storage unit 20 in advance. Next, the user inputs an instruction to designate a prediction error sample 25 to be analyzed to the analysis device 10, and the instruction reception unit 70 receives the instruction (step S12). Next, the diagnosis unit 30 calculates a plurality of metrics, determines each metric, and identifies a prediction error factor using a factor determination rule (step S13). Next, the action determination unit 40 creates an action proposal for eliminating the identified prediction error factor (step S14). Next, the visualization unit 50 visualizes information describing the analysis process (step S15). Then, the result output unit 60 displays the identification result of the prediction error factor, the action proposal, and the visualized information (step S16).

The analysis device 10 has been described above. According to the analysis device 10, a plurality of types of metrics are evaluated, and a factor according to a combination of the evaluation results is automatically identified. Therefore, according to the analysis device 10, it is possible to easily identify a factor of a prediction error in prediction using the prediction model on the basis of various viewpoints. In particular, in the analysis device 10, since the action determination unit 40 determines an action to be performed in order to eliminate a prediction error factor, the user can omit examination on what action needs to be performed. Furthermore, since the analysis device 10 includes the visualization unit 50, it is possible to visualize information describing an analysis process in the analysis device 10. Note that the configuration of the analysis device 10 described above is merely an example, and various modifications can be made. For example, the analysis device 10 may further include a processing unit that performs prediction using the prediction model 21.

Meanwhile, in the above description, specific examples of the factor determination rule and the action determination rule have been described in order to aid in understanding, but these are not limited to the above specific examples. For example, the following rules may be used.

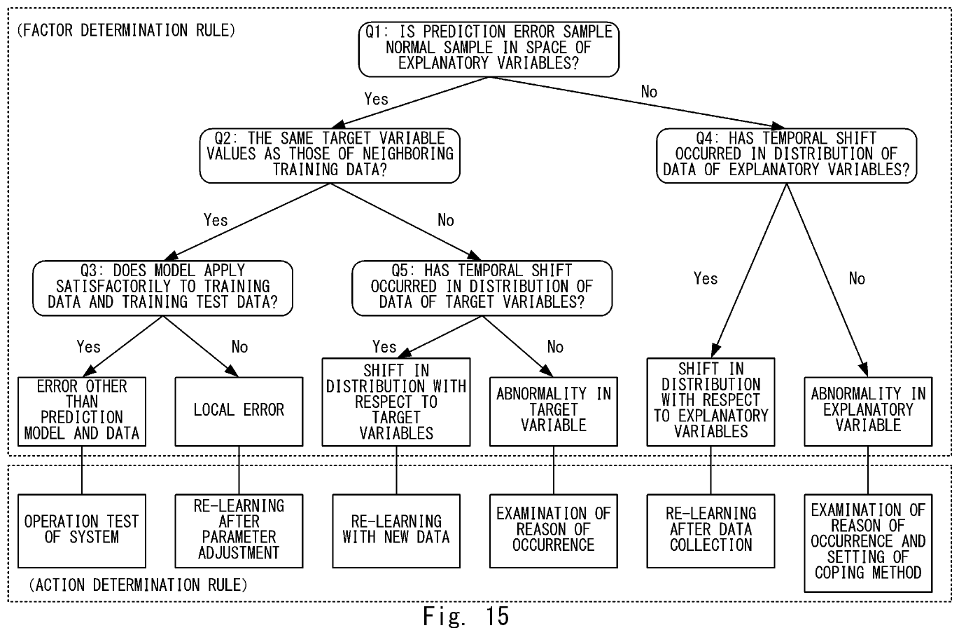

Hereinafter, specific examples different from the above examples will be described with respect to the factor determination rule and the action determination rule. FIG. 15 is a schematic diagram illustrating other specific examples of the factor determination rule and the action determination rule. Note that FIG. 15 illustrates a factor determination rule in a flowchart format. Since the factor determination rule illustrated in FIG. 15 has a larger number of metrics to be handled than the factor determination rules illustrated in FIGS. 5 and 6, more multifaceted analysis can be performed.

In the example of FIG. 15, the metric evaluation unit 31 calculates a maximum of five metrics and performs five determinations Q1 to Q5 corresponding thereto, and the factor identification unit 32 identifies a prediction error factor according to the factor determination rule in a flowchart format. Then, the action determination unit 40 creates an action proposal using an action determination rule for associating the prediction error factor with the action proposal for solving the prediction error factor on a one-to-one basis. Hereinafter, the configuration of the factor determination rule in a flowchart format illustrated in FIG. 15 and evaluation of metrics corresponding to each question Q appearing in the factor determination rule will be described.

In Q1, whether the prediction error sample 25 is a normal sample is determined from an abnormality score of an explanatory variable of the prediction error sample 25 with respect to the training data 22. In addition, in Q2, in a case where the determination result of Q1 is Yes, it is determined whether an actual value of an target variable of the prediction error sample 25 is similar to an actual value of an target variable of a neighboring training sample. By performing determination of Q1 and Q2, it is possible to determine whether the prediction error sample 25 is a normal sample with respect to the explanatory variable and the target variable when compared with the training data 22. Processing of the metric evaluation unit 31 corresponding to Q1 and Q2 can be implemented using an abnormality detection technique. For example, in a case where an abnormality detection technique called a hoteling method is used, in order to determine Q1, the metric evaluation unit 31 calculates a Mahalanobis distance of the prediction error sample 25 using a distribution of explanatory variables of the training data 22, and sets the Mahalanobis distance as an abnormality score. Similarly, in this case, in order to determine Q2, the metric evaluation unit 31 calculates a Mahalanobis distance of the prediction error sample 25 using a distribution of target variables of the neighboring training sample, and sets the Mahalanobis distance as an abnormality score. Then, with respect to the calculated abnormality score, the metric evaluation unit 31 determines whether the prediction error sample 25 is a normal sample using a threshold stored as the analysis control information 26. If the sample is determined to be an abnormal sample, the determination result of Q1 or Q2 is No.

In Q4, in a case where the determination result of Q1 is No, it is determined whether a temporal shift occurs in a data distribution by focusing on the explanatory variables of the training data 22 and the operation data 24. In addition, in Q5, in a case where the determination result of Q2 is No, it is determined whether a temporal shift occurs in the data distribution by focusing on the distribution of the target variables of the neighboring training sample and the sample (hereinafter, neighboring operation sample) in the operation data 24 located in the neighboring region. In this way, by focusing only on the sample of the neighboring region in Q5, the influence of a correlation between the explanatory variables and the target variables can be removed, and a temporal shift in a noise distribution of the target variables can be easily calculated. By performing determinations of Q4 and Q5, the diagnosis unit 30 determines, when the prediction error sample 25 is an abnormal sample, whether the reason why such an abnormal sample has appeared is a temporal shift in the data distribution. Processing of the metric evaluation unit 31 corresponding to Q4 and Q5 can be implemented using an inter-distribution distance estimation technique or a change point detection technique. For example, in a case where an inter-distribution distance estimation technique is used, in order to determine Q4, the metric evaluation unit 31 calculates an inter-distribution distance such as a Kullback-Leibler distance using a distribution of actual values of the explanatory variables of the training data 22 and the operation data 24, and sets the calculated inter-distribution distance as a magnitude of distribution shift of data. Similarly, in this case, in order to determine Q5, the metric evaluation unit 31 calculates an inter-distribution distance such as the Kullback-Leibler distance using distributions of actual values of the target variables of the neighboring training sample and the neighboring operation sample, and sets the calculated inter-distribution distance as a magnitude of distribution shift of data. Then, with respect to the calculated magnitude of distribution shift of data, the metric evaluation unit 31 determines whether or not a temporal shift occurs in the data distribution using the threshold stored as the analysis control information 26.

Q3 is determined when the determination results of Q1 and Q2 are both Yes (that is, in a case where the prediction error sample 25 is determined to be a normal sample in comparison with the training data 22). Q3 is a question of determining whether the prediction model 21 has performed neither underfitting nor overfitting on the training data 22 near the prediction error sample 25. By outputting the determination result of Q3, it is possible to determine whether the factor of the prediction error is in the prediction model 21. Processing of the metric evaluation unit 31 corresponding to Q3 can be implemented using various evaluation methods of the prediction model. As an example, there is a method of using an evaluation metric of a prediction model such as a mean square error. Specifically, in order to determine Q3, the metric evaluation unit 31 calculates a mean square error using the neighboring training sample and the prediction model 21, and compares the mean square error with a first threshold stored as the analysis control information 26, thereby determining the presence or absence of underfitting for the neighboring training sample. Further, the metric evaluation unit 31 calculates a mean square error using the sample (neighboring test sample) in the training test data 23 located in the neighboring region and the prediction model 21, and compares the mean square error with a second threshold stored as the analysis control information 26. As a result, the metric evaluation unit 31 determines the presence or absence of overfitting for the neighboring training sample. Note that the first threshold and the second threshold may be the same or different. In this manner, it is determined whether or not both underfitting and overfitting have occurred. In a case where neither underfitting nor overfitting has occurred, it is determined that the prediction model 21 applies satisfactorily to the training data and the training test data, and the determination result of Q3 is Yes.

A major difference between the factor determination rule illustrated in FIG. 14 and the factor determination rule illustrated in FIG. 6 is that determinations Q2 and Q5 related to the target variables are added to the factor determination rule in FIG. 14. In Q2, it is determined whether the actual values of the target variables of the prediction error sample 25 are normal values in comparison with the target variables of the neighboring training sample. In addition, in Q5, when the actual values of the target variables of the prediction error sample 25 are abnormal, it is determined whether the reason why such an abnormal sample has occurred is a temporal shift in the distribution of the target variables of the neighboring operation sample. By adding these two determinations, it is possible to perform analysis focusing on the values of the target variables, and it is possible to identify a prediction error factor in more detail than the case of using the factor determination rule illustrated in FIG. 6.

Next, a dependence relationship of each question Q in the factor determination rule of FIG. 15 and a prediction error factor to be determined will be described. First, when the determination result of Q1 is No, it means that there are not sufficient neighboring training samples in the training data 22. At this time, even if the prediction model 21 applies satisfactorily to the neighboring training samples, it is difficult for the prediction model 21 to accurately predict about the prediction error sample 25. Therefore, in subsequent Q4, it is determined whether the reason why a sample difficult to predict such as the prediction error sample 25 has occurred is a shift in the distribution of data of the explanatory variables. When the determination result of Q4 is No, it is concluded that a prediction error factor is that the prediction error sample 25 is a sample having an abnormal explanatory variable value generated regardless of the shift in the data distribution. That is, it is concluded that the factor of the prediction error is an abnormality in the target variables due to some reason. In a case where the determination result of Q4 is Yes, the frequency at which a sample having a value of an abnormal explanatory variable is generated increases due to the temporal shift in the distribution of the explanatory variables, and as a result, it is concluded that the prediction error sample 25 having the value of the abnormal explanatory variable has been generated and the prediction error has occurred.

If the determination result of Q1 is Yes, subsequently, it is determined whether or not it is possible to accurately predict actual values of the target variables of the prediction error sample 25 when the prediction model 21 has appropriately learned actual values of the neighboring training sample in Q2. If the determination result of Q2 is No, the value of the target variable of the prediction error sample 25 is an abnormal value with respect to the value of the target variable of the neighboring training sample, which means that it is difficult to perform highly accurate prediction. Therefore, subsequently, it is determined whether the reason why the sample having such an abnormal target variable is generated is a shift in the distribution of the data of the target variables in Q5. If the determination result of Q5 is No, it is concluded that a prediction error factor is that the prediction error sample 25 is a sample having an abnormal target variable value generated regardless of the shift in the data distribution. That is, it is concluded that the factor of the prediction error is an abnormality in the explanatory variables due to some reason. If the determination result of Q5 is Yes, it is concluded that the frequency at which a sample having an abnormal target variable value is generated increases due to the temporal shift in the distribution with respect to the target variables, and as a result, the prediction error sample 25 having an abnormal target variable value has been generated and the prediction error has occurred.

If the determination result of Q2 is Yes, subsequently, it is determined in Q3 whether the prediction model 21 has appropriately learned the actual values of the target variables of the neighboring training sample. If the determination result of Q3 is Yes, since the prediction model 21 is assumed to be a prediction model with high prediction accuracy, it is expected that no prediction error occurs. Therefore, a factor other than the prediction model and data, such as a sample without a prediction error being analyzed as the prediction error sample 25 due to a malfunction of the system (analysis device 10) (a malfunction of a user interface or the like) or an erroneous operation of the user of the system, is conceivable. In addition, if the determination result of Q3 is No, this corresponds to a case where the prediction model 21 has not appropriately learned the actual values of the target variables of the neighboring training sample due to overfitting or underfitting. Therefore, in this case, it is concluded that the prediction model 21 is a model having a local error around the prediction error sample 25.

Next, the action determination rule of FIG. 15 will be described. First, in a case where a prediction error factor is “an error other than the prediction model and data”, it is necessary to examine whether or not a problem such as a malfunction of the system or an erroneous operation of the user occurs by performing an operation test of the system (analysis device 10) or the like. Therefore, in this case, the action determination unit 40 creates an action proposal recommending execution of such an action with reference to the action determination rule. In a case where the prediction error factor is a “local error”, there is a high possibility of overfitting or underfitting, and thus it is necessary to adjust hyperparameters at the time of learning the prediction model and perform re-learning. Therefore, in this case, the action determination unit 40 creates an action proposal recommending execution of such an action with reference to the action determination rule. In a case where the prediction error factor is “shift in a distribution with respect to target variables”, it is necessary to discard old data and re-learn the prediction model with only new data in order to adapt the prediction model to the shifted distribution of the target variables. Therefore, in this case, the action determination unit 40 creates an action proposal recommending execution of such an action with reference to the action determination rule. In a case where the prediction error factor is “abnormality in target variables”, it means that the prediction error sample 25 has an abnormal target variable value regardless of a shift in the distribution, and it is necessary to investigate the cause of occurrence of such a sample. Therefore, in this case, the action determination unit 40 creates an action proposal recommending execution of such an action with reference to the action determination rule. In a case where the prediction error factor is “shift in a distribution with respect to explanatory variables”, it means that a large number of pieces of operation data are present in the region of the explanatory variables that the prediction model 21 has not learned. Therefore, it is possible to improve the accuracy of the prediction model by adding the operation data to the training data and performing re-learning. Therefore, in this case, the action determination unit 40 creates an action proposal recommending execution of such an action with reference to the action determination rule. In a case where the prediction error factor is “abnormality in explanatory variables”, it means that the prediction error sample 25 has an abnormal explanatory variable value regardless of a shift in the distribution. For this reason, it is necessary to investigate the reason why such a sample has occurred and determine a coping method when a similar sample occurs in the future. Therefore, in this case, the action determination unit 40 creates an action proposal recommending execution of such an action with reference to the action determination rule.

Although the present invention has been described above with reference to the example embodiments, the present invention is not limited to the above. Various modifications that can be understood by those skilled in the art can be made to the configuration and details of the present invention within the scope of the invention.

Some or all of the above example embodiments may be described as the following supplementary notes, but are not limited to the following.

### (Supplementary Note 1)

An analysis device including:
a metric evaluation means for calculating and evaluating a plurality of types of metrics with respect to a prediction model, data of explanatory variables used in the prediction model, or data of target variables used in the prediction model; and
a factor identification means for identifying a factor of an error in prediction by the prediction model according to a combination of evaluation results of the plurality of types of the metrics.

### (Supplementary Note 2)

The analysis device according to Supplementary note 1, wherein the factor identification means identifies a factor of an error in prediction by the prediction model according to a rule for associating combinations of evaluation results of the plurality of types of the metrics with factors.

### (Supplementary Note 3)

The analysis device according to Supplementary note 2, wherein the factor identification means identifies a factor of an error in prediction by the prediction model according to a combination of an evaluation result of a predetermined metric among the plurality of types of the metrics and an evaluation result of the metric selected according to the evaluation result of the predetermined metric.

### (Supplementary Note 4)

The analysis device according to any one of Supplementary notes 1 to 3, further including an instruction reception unit configured to receive an instruction to designate a calculation algorithm or an evaluation algorithm for the metrics,
wherein the metric evaluation means calculates or evaluates the metrics by the calculation algorithm or the evaluation algorithm designated by the instruction.

### (Supplementary Note 5)

The analysis device according to Supplementary note 2, further including an instruction reception unit configured to receive an instruction to designate the rule,
wherein the factor identification means identifies a factor of an error in prediction by the prediction model according to the rule designated by the instruction.

### (Supplementary Note 6)

The analysis device according to any one of Supplementary notes 1 to 5, further including an action determination means for determining an action for eliminating the factor identified by the factor identification means.

### (Supplementary Note 7)

The analysis device according to any one of Supplementary notes 1 to 6, further including a visualization means for generating image data of a predetermined graph according to the metrics.

### (Supplementary Note 8)

The analysis device according to Supplementary note 3, further including a visualization means for generating image data representing a flowchart defining the metric used to identify the factor and an order of using the metric and a transition history in the flowchart.

### (Supplementary Note 9)

An analysis method including:
calculating and evaluating a plurality of types of metrics with respect to a prediction model, data of explanatory variables used in the prediction model, or data of target variables used in the prediction model; and
identifying a factor of an error in prediction by the prediction model according to a combination of evaluation results of the plurality of types of the metrics.

### (Supplementary Note 10)

A non-transitory computer-readable medium storing a program causing a computer to execute:
a metric evaluation step of calculating and evaluating a plurality of types of metrics with respect to a prediction model, data of explanatory variables used in the prediction model, or data of target variables used in the prediction model; and
a factor identification step of identifying a factor of an error in prediction by the prediction model according to a combination of evaluation results of the plurality of types of the metrics.

### REFERENCE SIGNS LIST

1 ANALYSIS DEVICE
2 METRIC EVALUATION UNIT
3 FACTOR IDENTIFICATION UNIT
10 ANALYSIS DEVICE
20 STORAGE UNIT
21 PREDICTION MODEL
22 TRAINING DATA
23 TRAINING TEST DATA
24 OPERATION DATA
25 PREDICTION ERROR SAMPLE
26 ANALYSIS CONTROL INFORMATION
30 DIAGNOSIS UNIT
31 METRIC EVALUATION UNIT
32 FACTOR IDENTIFICATION UNIT
40 ACTION DETERMINATION UNIT
50 VISUALIZATION UNIT
60 RESULT OUTPUT UNIT
70 INSTRUCTION RECEPTION UNIT
150 INPUT/OUTPUT INTERFACE
151 NETWORK INTERFACE
152 MEMORY
153 PROCESSOR

What is claimed is:

1. An analysis device comprising:
at least one memory storing instructions; and
at least one processor configured to execute the instructions to:
calculate and evaluate a plurality of types of metrics with respect to a prediction model, data of explanatory variables used in the prediction model, or data of target variables used in the prediction model; and
identify a factor of an error in prediction by the prediction model according to a combination of evaluation results of the plurality of types of the metrics.

2. The analysis device according to claim 1, wherein the processor is configured to execute the instructions to identify a factor of an error in prediction by the prediction model according to a rule for associating combinations of evaluation results of the plurality of types of the metrics with factors.

3. The analysis device according to claim 2, wherein the processor is configured to execute the instructions to identify a factor of an error in prediction by the prediction model according to a combination of an evaluation result of a predetermined metric among the plurality of types of the metrics and an evaluation result of the metric selected according to the evaluation result of the predetermined metric.

4. The analysis device according to claim 1, wherein the processor is further configured to execute the instructions to:
receive an instruction to designate a calculation algorithm or an evaluation algorithm for the metrics, and
calculate and evaluate the metrics by the calculation algorithm or the evaluation algorithm designated by the instruction.

5. The analysis device according to claim 2, wherein the processor is further configured to execute the instructions to:
receive an instruction to designate the rule, and
identify a factor of an error in prediction by the prediction model according to the rule designated by the instruction.

6. The analysis device according to claim 1, wherein the processor is further configured to execute the instructions to determine an action for eliminating the identified factor.

7. The analysis device according to claim 1, wherein the processor is further configured to execute the instructions to generate image data of a predetermined graph according to the metrics.

8. The analysis device according to claim 3, wherein the processor is further configured to execute the instructions to generate image data representing a flowchart defining the metric used to identify the factor and an order of using the metric and a transition history in the flowchart.

9. An analysis method comprising:
calculating and evaluating a plurality of types of metrics with respect to a prediction model, data of explanatory variables used in the prediction model, or data of target variables used in the prediction model; and
identifying a factor of an error in prediction by the prediction model according to a combination of evaluation results of the plurality of types of the metrics.

10. A non-transitory computer-readable medium storing a program causing a computer to execute:
a metric evaluation step of calculating and evaluating a plurality of types of metrics with respect to a prediction model, data of explanatory variables used in the prediction model, or data of target variables used in the prediction model; and
a factor identification step of identifying a factor of an error in prediction by the prediction model according to a combination of evaluation results of the plurality of types of the metrics.
